(19) United States
(12) Patent Application Publication
(10) Pub. No.: US 2016/0162609 A1
(43) Pub. Date: Jun. 9, 2016

(54) DEVICE TO VERIFY STRUCTURAL CONSISTENCY

(71) Applicant: Enrique Garcia Castaneda, Lomas de Santa Fe (MX)

(72) Inventor: Enrique Garcia Castaneda, Lomas de Santa Fe (MX)

(21) Appl. No.: 14/964,202

(22) Filed: Dec. 9, 2015

Related U.S. Application Data
(60) Provisional application No. 62/089,594, filed on Dec. 9, 2014.

(51) Int. Cl. G06F 17/50

(52) U.S. Cl. CPC G06F 17/5004

(57) ABSTRACT

The present invention relates to device to verify the structural consistency that can be used as a tool to know, immediately, the state which is a structure, such as a house, building, highway, bridge, container, dam, etc., after having experienced an event of great magnitude that might compromise its stability, integrity, or even its viability. This device will allow taking timely decisions to an event that can endanger human lives and material resources. In addition to its use as a tool of information in an emergency, this invention can use to assess the State of structures containing with the passage of time and the weather conditions.

### CROSS REFERENCE TO RELATED APPLICATIONS

This application is a non-provisional of provisional application No. 62/089,594 filed Dec. 9, 2014. The subject matter of provisional application No. 62/089,594 is hereby incorporated by reference in its entirety.

### TECHNICAL FIELD

The present invention relates to device to verify the structural consistency that can be used as a tool to know, immediately, the state which is a structure, such as a house, building, highway, bridge, container, dam, etc., after having experienced an event of great magnitude that might compromise its stability, integrity, or even its viability.

### BACKGROUND

Currently, all structures that surround us (house, building, highway, bridge, container, dam, etc.) are affected by several natural phenomena, emerging events, as well as to the passage of time. This affects in different proportion its structural stability to the point that its use is no longer safe or is practically useless.

These situations can happen over a long time—or in the case of certain events—in a matter of seconds. These events can be (guidance more not limited):

Natural disasters: Earthquakes, hurricanes, tornadoes, etc., as well as its different effects (storms, tsunamis, avalanches, landslides, etc.);

Unnatural disasters: Explosions, accidents, sabotage, etc. as well as its various effects.

But today there is not a tool which allows knowing the state in which a structure is immediately after an event of great magnitude that might compromise the stability, integrity or even the feasibility of such a structure.

This is why major natural events which this device is intended to serve are the earthquakes.

There is already an invention that serves as a system of seismic alert for Mexico City which allows alert with a short advance (30-50 seconds) the arrival of a seismic event from tri-axial accelerometers installed in monitoring bases installed in the States of Guerrero and Oaxaca.

Other devices measure the intensity of the earthquake in different parts of a structure, such is the case of the Digital Acelerometric System for Structures (DASS), which uses the same accelerometers used by monitoring stations mentioned in the previous point and installed in various parts of a building to monitor the intensity of the earthquake in different parts of a structure.

This system is very expensive, difficult installation and high maintenance costs. It only measures the intensity of the earthquake, but not the deformation or deviation from the original state of the structure.

### SUMMARY

The device of the present invention is a combination of hardware and software that will allow assessing the status in which a determined structure, after an event that may jeopardize its structural integrity, through a comparison of reading of its current state against an initial reading before said event.

### BRIEF DESCRIPTION OF THE DRAWINGS

The above objectives and others, as well as the characteristics and advantages of the present invention will be understood more clearly from the following description in conjunction with the accompanying figures, in which:

FIG. 1 shows a structure that can be monitored with the device of the present invention.

FIG. 2 shows the embedded chips installed at predetermined points of the structure.

FIG. 3 shows the first reading carried out with the device.

FIG. 4 shows an image that represents the structure after the event.

FIG. 5 shows the reading of the structure, carried out with the device, after the event.

### DETAILED DESCRIPTION

Below is described, in detail, a preferred embodiment of the present invention, by referring to the attached figures.

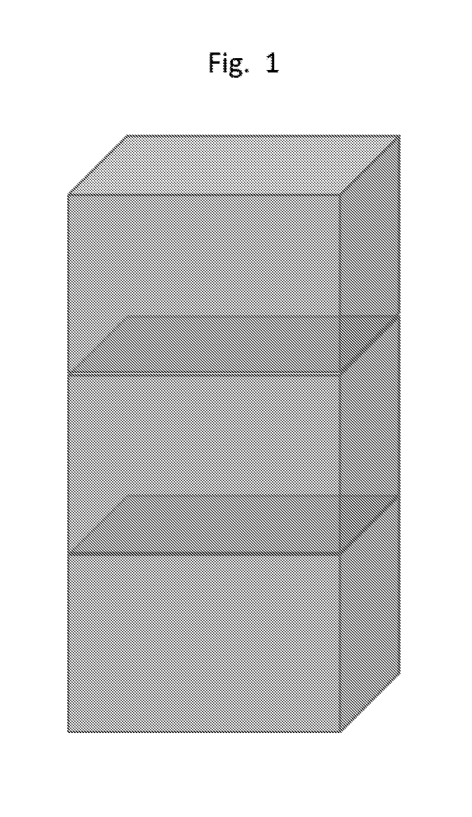

FIG. 1 shows an exemplary structure that can be monitored with the device of the present invention. In this case it may be a three-floor building.

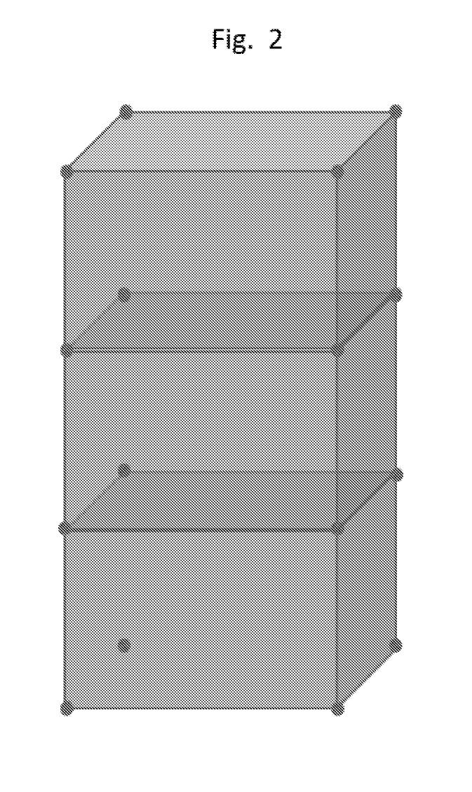

FIG. 2 shows the installation of indoor positioning systems at predetermined points of a construction, either during or after the construction of the same.

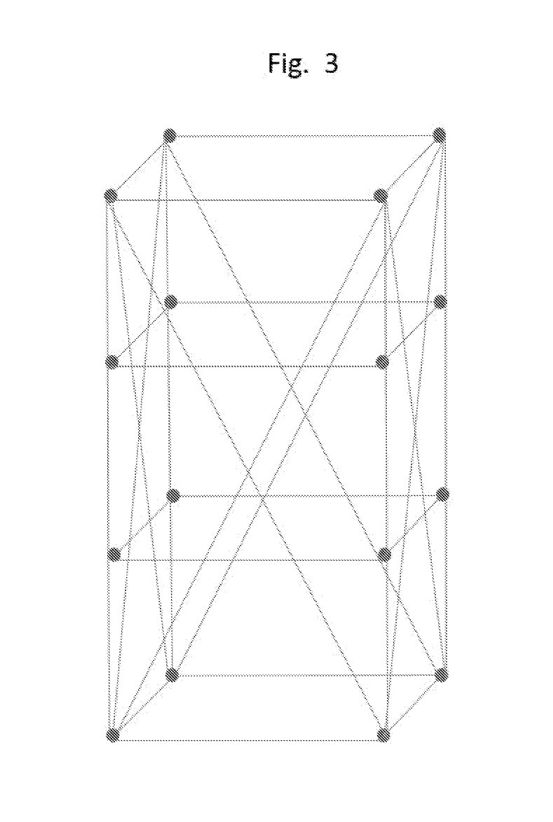

FIG. 3 shows that, once installed the indoor positioning system, can be taken first reading through the hardware, which allows obtaining a basis of comparison for future readings.

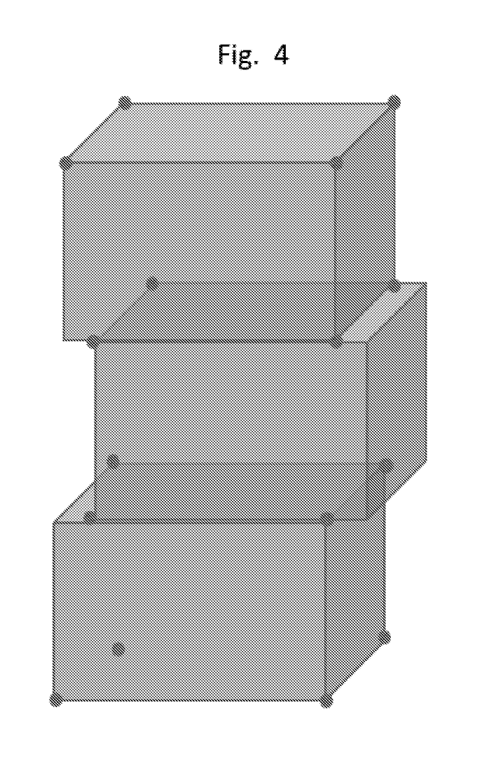

FIG. 4 shows an image that represents a three-floor building, after having experienced the effects of the event.

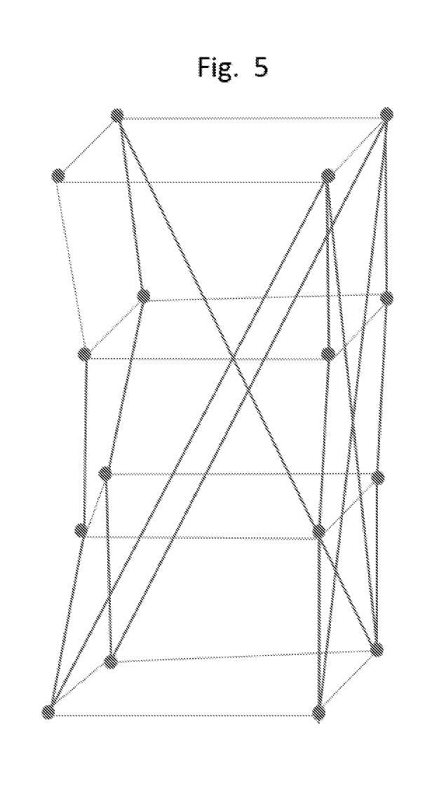

FIG. 5 shows take reading of the structure after the event to compare it with the initial reading and to detect variations.

What is claimed is:

1. A device to verify the structural consistency, characterized in that it uses as trackers, to take the first reading, indoor positioning systems enable precise reference points in parts of the structure in which are interested in measuring the stability and integrity of a structure.

2. The device to verify the structural consistency of claim 1, characterized in that the indoor positioning systems can be integrated to the structure during construction of new buildings and also further way is integrated into an existing structure.

3. The device to verify the structural consistency of claims 1 and 2, characterized in that, once installed, the device will take the initial reading of the position of the indoor positioning systems inside and outside the structure.

4. The device to verify the structural consistency of claim 3, characterized in that the initial reading will take place with a computing device (Tablet, laptop, desktop, server, etc.) through designed/written software for this purpose.

5. The device to verify the structural consistency of claims 3 and 4, characterized in that the task of the software is to measure the relationship of the distance between multiple indoor positioning systems within the structure in question in relation to another device installed outside the structure which will act as fixed reference.

6. The device to verify the structural consistency of claim 1, characterized in that it is used an algorithm that calculates the distance that exists between each of the chips, thereby creating a sort of virtual network, which will serve as the baseline against which subsequent readings will be measured, and the initial measurement recorded permanently.

7. The device to verify the structural consistency of claims 1 and 6, characterized in that devices will perform constant readings, so that when the structure is fitted with the device and experience some phenomenon that may affect its integrity, readings will be stored for further measures.

8. The device to verify the structural consistency of claim 7, characterized in that when a new reading is performed, the algorithm compares deviations or differences between the initial reading, and a subsequent reading, which will make evident the effects to the structure that can compromise the integrity of the structure or building.
